(19) United States
(12) Patent Application Publication
(10) Pub. No.: US 2018/0189214 A1
(43) Pub. Date: Jul. 5, 2018

(54) CROSSTALK CANCELLATION TRANSMISSION BRIDGE

(71) Applicant: INTEL CORPORATION, Santa Clara, CA (US)

(72) Inventors: James A. MCCALL, Portland, OR (US); Zhichao ZHANG, Chandler, AZ (US); Qin LI, Folsom, CA (US); Xiang LI, Portland, OR (US); John R. DREW, Hillsboro, OR (US)

(21) Appl. No.: 15/396,268

(22) Filed: Dec. 30, 2016

(51) Int. Cl. G06F 13/40; H01R 12/72

(52) U.S. Cl. CPC G06F 13/4022; G06F 13/4068; H01R 12/721

(57) ABSTRACT

Devices include a connecting card that may be used in a memory connector. The connecting card may include a substrate including a first substrate region and a second substrate region, a plurality of adjacent signal pathways extending from the first substrate region to the second substrate region, and a capacitor positioned between each of the adjacent signal pathways. Other embodiments are described and claimed.

### TECHNICAL FIELD

Embodiments described herein relate to devices, systems and methods for providing crosstalk cancellation utilizing a connecting card.

### BACKGROUND

As computing systems become more complex and processor clock speeds and corresponding signal frequencies increase, crosstalk between various signal routing lines that interconnect components of the system can lead to degradation of the data signals. For a typical memory channel, inductive crosstalk coupling may be a serious signaling limitation.

### BRIEF DESCRIPTION OF THE DRAWINGS

Embodiments are described by way of example, with reference to the accompanying drawings, in which like reference numerals may refer to similar elements.

FIG. 1 illustrates a view of a connecting card positioned in a connector, in accordance with certain embodiments.

FIG. 2 illustrates a view of a memory channel including signal pathways, in accordance with certain embodiments.

FIG. 3 illustrates a side view of a signal pathway, in accordance with certain embodiments.

FIG. 4 illustrates a side view of a signal pathway, in accordance with certain embodiments.

FIG. 5 illustrates a connecting card positioned in a connector, in accordance with certain embodiments.

FIG. 6 illustrates a flowchart of operations, in accordance with certain embodiments.

FIG. 7 illustrates an electronic system arrangement in which embodiments may find application.

### DESCRIPTION OF EMBODIMENTS

References in the specification to “embodiments,” “certain embodiments,” “an embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Certain embodiments relate to the use of a connecting card that provides crosstalk cancellation in a system including memory. Embodiments may include devices, systems, and methods.

For certain systems where a multi-drop bus topology is employed, memory capacity and memory bandwidth may represent competing requirements. For example, as more dual in-line memory modules (DIMMs) are connected to a memory channel, the data transfer rate may have to be reduced to accommodate the increased bus loading. Similarly, as data transfer rate increases, a fewer number of DIMMs may need to be connected in a memory channel to reduce electrical loading. As a result, it may be useful to include a system that can support more DIMMs while also keeping the bus loading (number of loads) low. It should be appreciated that while DIMMs are described in certain embodiments, embodiments may also relate to the use of other types of memory modules, and the memory positioned on the modules may include, for example, volatile memory such as, for example, DRAM (dynamic random access memory) technology such as JEDEC DDR4 and the like, and non-volatile memory such as, for example, byte addressable three dimensional crosspoint memory.

Volatile memory requires power to maintain the state of data stored by the medium. Examples of volatile memory may include, but are not limited to, various types of random access memory (RAM), such as dynamic random access memory (DRAM), and static random access memory (SRAM). A type of DRAM that may be used in memory modules such as DIMMs is synchronous dynamic random access memory (SDRAM). In certain embodiments, DRAM of at least some of the memory modules may comply with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at www.jedec.org).

Non-volatile memory does not require power to maintain the state of data stored by the medium. Examples of non-volatile memory may include, but are not limited to, one or more of: solid state memory (such as planar or 3D NAND flash memory or NOR flash memory), three dimensional crosspoint memory, magnetoresistive random access memory (MRAM), storage devices that use chalcogenide phase change material (e.g., chalcogenide glass), byte addressable non-volatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), other various types of non-volatile random access memories (RAMs), and magnetic storage memory. Certain of the memory types listed above may overlap with other memory types listed.

Certain embodiments relate to the use of a split channel concept that provides two DIMMs per channel memory capacity while utilizing one DIMM per channel loading in terms of signaling perspective. An issue with such a split channel configuration is that both DIMM slots need to be populated to obtain full bandwidth. In accordance with certain embodiments, a transmission bridge card or connecting card (also known as a connecting bridge or a shorting card) may be inserted into one of the DIMM slots, in order to provide full bandwidth. The connecting card is configured to mitigate crosstalk coupling.

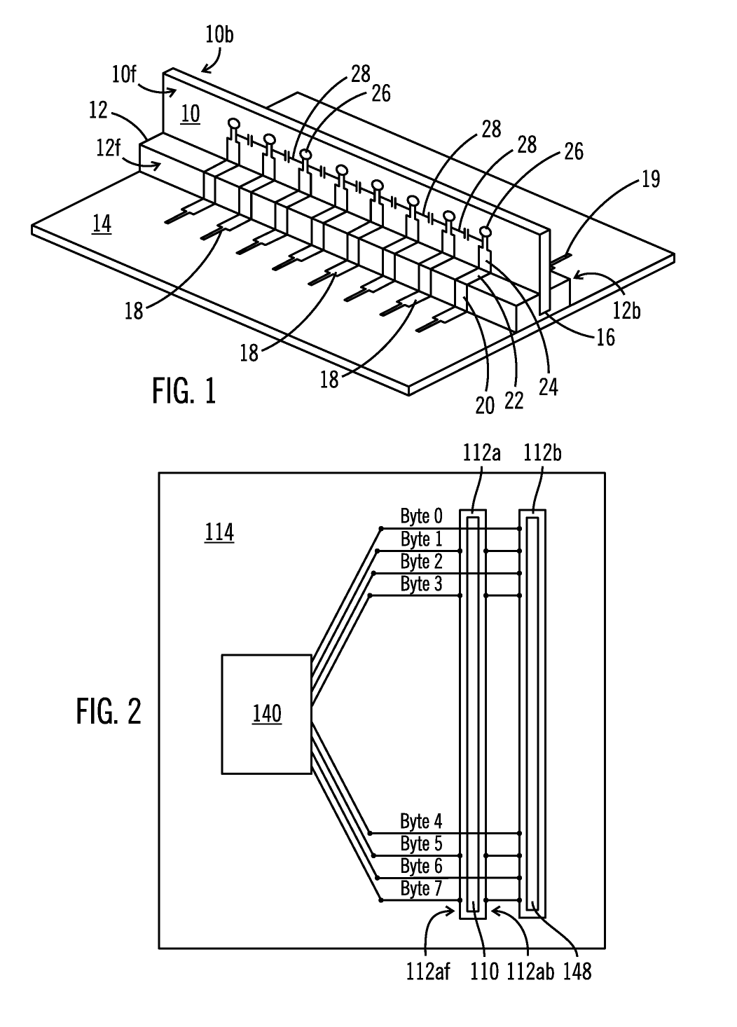

FIG. 1 illustrates an embodiment including a connecting card 10 in a memory connector such as DIMM connector 12 (also known as a DIMM socket or DIMM slot) on a substrate that may comprise a printed circuit board (PCB) 14 into which the DIMM connector 12 is attached, using, for example, a through hole connection or a surface mount connection. The DIMM connector 12 includes a front side 12f and a back side 12b, and includes a slot 16 extending down a central portion thereof into which the connecting card 10 may fit. The connecting card 10 may comprise a substrate including signal pathways extending from a first connecting card substrate region on the front side 10f to a second connecting card substrate region on the back side 10b. A plurality of traces 18 extend along a portion of the surface of the PCB 14 and are electrically connected to trace portions 20 on the DIMM connector 12. The trace portions 20 on the DIMM connector 12 extend into trace portions 22 on the DIMM connector, which are in electrical contact with trace regions 24 in the first connecting card substrate region on the front side 10f of the connecting card 10. The trace regions 24 on the first front side 10f of the connecting card 10 extend to vias 26, which deliver the signal through the thickness of the connecting card 10, to the second connecting card substrate region on the back side surface 10b of the connecting card 10. The signal is then routed to the back side 12b of the DIMM connector 12, and to trace regions 19 on the PCB 14 behind the DIMM connector 12. Other trace configurations, for example, extending through openings on the front side 12f and/or the back side 12b, are also possible.

The various transitions as the signal propagates through the system, including from the traces 18 on the PCB 14 to the trace regions 20 on the front side 12f of the DIMM connector 12, through the connecting card 10, to the back side 12b of the DIMM connector 12, and back to traces 19 on the PCB 14, may deleteriously impact the signal performance due to the added insertion loss and extra far end crosstalk (FEXT). Certain embodiments include a capacitor positioned between the data signal pathways in the connecting card 10, to increase capacitive coupling and effectively cancel the FEXT. For example, in the embodiment illustrated in FIG. 1, a capacitor 28 is positioned to extend between adjacent signal pathways (each including trace region 24 leading to via region 26). The capacitor 28 may be configured to increase capacitive coupling and effectively cancel out the FEXT. In certain embodiments, the capacitor may be optimized to also cancel noise from other portions of the data channel to improve the overall system performance.

The capacitors 28 may be discrete capacitor structures that are separately formed and then coupled to the connecting card 10. In certain embodiments the capacitors 28 may be positioned on an outer surface of the connecting card 10. Alternatively, some or all of the capacitors 28 may be embedded within the thickness of the connecting card 14. The capacitors 28 may also be formed in or on the connecting card 14 during its fabrication. For example, the connecting card 10 may in certain embodiments comprise a multi-layer substrate including metal and non-metal layers, and the capacitors 28 may be shaped during formation of the various metal and non-metal layers of the substrate 14, using any suitable technique.

FIG. 2 illustrates a view of a system comprising a memory channel including signal pathways extending from a device such as, for example, a memory controller in a central processing unit (CPU) 140 positioned on a substrate that may be a PCB 114. A plurality of DIMM connectors include a first connector 112a and a second connector 112b in a memory region on the PCB 114. The connectors 112a, 112b each include a slot region that is sized to accept a DIMM or a connecting card. Connector 112a includes a connecting card 110 positioned therein, and connector 112b includes a DIMM 148 positioned therein.

The signal pathways illustrated in FIG. 2 include eight byte lanes designated as Byte 0 through Byte 7. The signal pathways for the byte lanes are split and include a group that electrically connects to the connector 112a and a group that avoids electrical connection to the connector 112a and electrically connects directly to the connector 112b. The signal pathway for each of the odd byte lanes as it extends from the connector 112a through the connecting card 110 is not shown in FIG. 2. The even byte lanes, including Byte 0, Byte 2, Byte 4, and Byte 6, all are connected directly to the memory connector 112b and DIMM 148 positioned therein. While FIG. 2 shows the signal pathways for Byte 0, Byte 2, Byte 4, and Byte 6 extending across the connector 112a and the connecting card 110 therein, there is no electrical connection to the memory connector 112a or to the connecting card 110.

The signal pathway for the odd byte lanes, including Byte 1, Byte 3, Byte 5, and Byte 7, is electrically connected to the connector 112a on the front side 112af. The signal pathway for Byte 1, Byte 3, Byte 5, and Byte 7 then extends to the connecting card 110 and exits the connecting card 110 and extends to the back side 112ab of the connector 112a, where it is routed to the connector 112b and the DIMM 148 positioned therein. Another way to describe the configuration is that the connecting card 110 in the connector 112a shorts the signal through the connector 112a for the odd byte lanes, and the even byte lanes are isolated from the connector 112a and connecting card 110 and are routed directly to the connector 112b.

While various embodiments, including that illustrated in FIG. 2 as discussed above, may include a connector and a connecting card that include signal pathways that enter and exit the connector and the connecting card on front and back sides thereof, other embodiments may include a structure in which the signal pathways are positioned on the same side of the connector and connecting card for both entering and exiting the connector and the connecting card, or on adjoining sides of the connector and the connecting card.

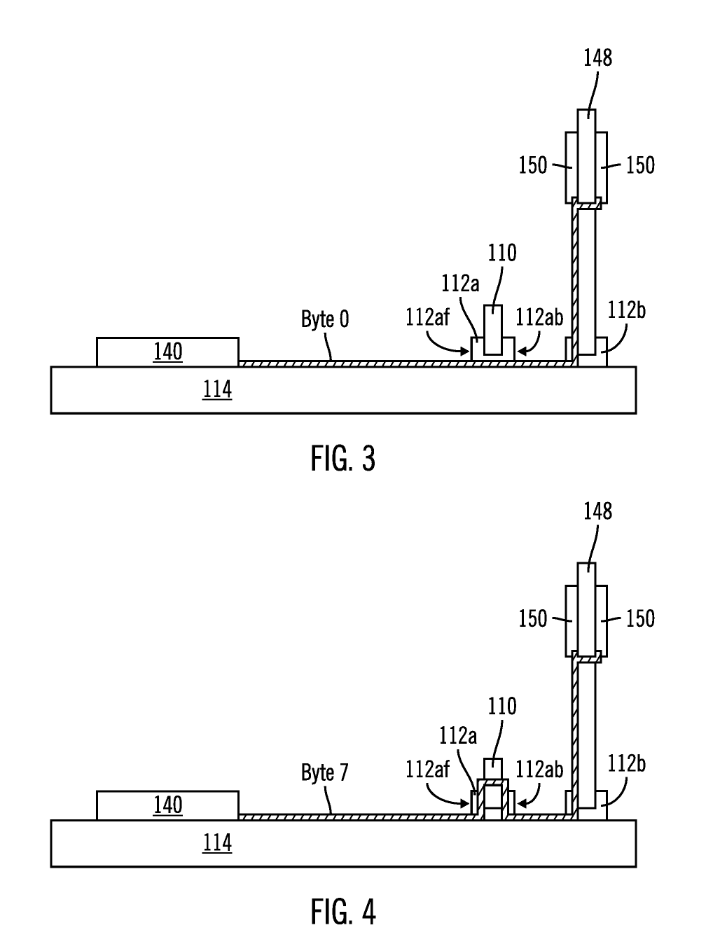

FIGS. 3-4 illustrate side views of the signal pathway in the split channel configuration of FIG. 2. FIG. 3 shows a side view of the signal pathway looking from an even byte lane such as Byte 0, toward the center of the system (downward from the top of FIG. 2). The signal pathway of Byte 0 (hatched in FIG. 3) extends from the CPU 140 towards the connectors 112a, 112b. The signal pathway bypasses the card 110 in the connector 112a, and extends to the DIMM 140 in connector 112b. As illustrated in FIGS. 3-4, the DIMM may include a plurality of memory chips 150 of any suitable memory type.

FIG. 4 shows a side view of the signal pathway from an odd byte lane such as Byte 7, toward the center of the system (upward from the bottom of FIG. 2). The signal pathway of Byte 7 (hatched in FIG. 4) extends from the CPU 140 towards the connectors 112a, 112b. The signal pathway extends to the connector 112a at the first side 112af, then extends to and through the connecting card 110, and exits the connector 112a at the back side 112ab and extends to the DIMM 140 in connector 112b.

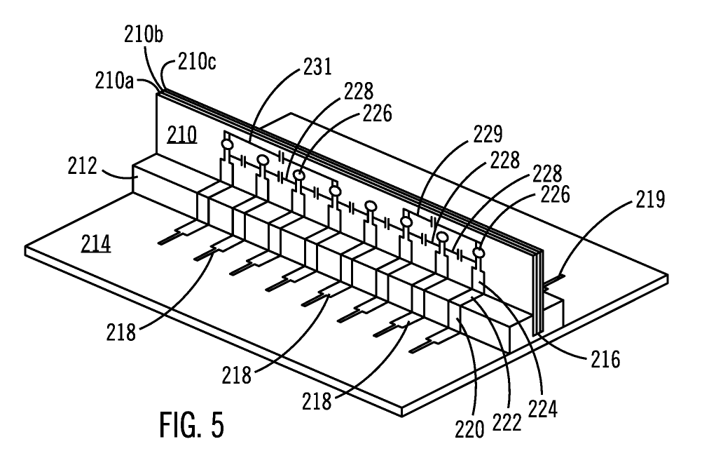

As noted above, the presence of capacitors between signal pathways in the connection card can cancel out crosstalk in the system. While FIG. 1 illustrates an embodiment with one capacitor 28 between adjacent signal pathways, a variety of other configurations are also possible. For example, FIG. 5 illustrates an embodiment similar to that illustrated in FIG. 1, including a connecting card 210 in a memory connector such as DIMM connector 212 on a substrate 214. The DIMM connector 212 includes a slot 216 extending down a central portion thereof, and the connecting card 210 is positioned in the slot 216. A plurality of traces 218 extend along a portion of the surface of the substrate and are electrically connected to trace portions 220 on the DIMM connector 212. The trace portions 220 extend to trace portions 222, which are in electrical contact with trace regions 224 on the connecting card 210. The trace regions 224 on the connecting card 210 extend to vias 226, which deliver the signal through the thickness of the connecting card 210 to the back side of the DIMM connector 212, and to trace regions 219 on the substrate 214 behind the DIMM connector 212. The connecting card 210 includes capacitors 228 positioned between adjacent signal pathways similar to the capacitors 28 in FIG. 1. The embodiment of FIG. 5 also includes additional capacitors 229, 231 positioned between certain signal pathways. The additional capacitors 229, 231 may provide additional crosstalk and noise cancellation and further improve the system performance. Any number of additional capacitors may be positioned between various signal pathways in the connecting card.

FIG. 5 also illustrates that the connecting card 210 may be a multi-layer substrate including metal and non-metal layers, such as in a PCB, including, for example, layers 210a, 210b, and 210c. One or more of the capacitors 228, 229, 231 may be embedded and/or formed within one or more of the layers 210a, 210b, and 210c.

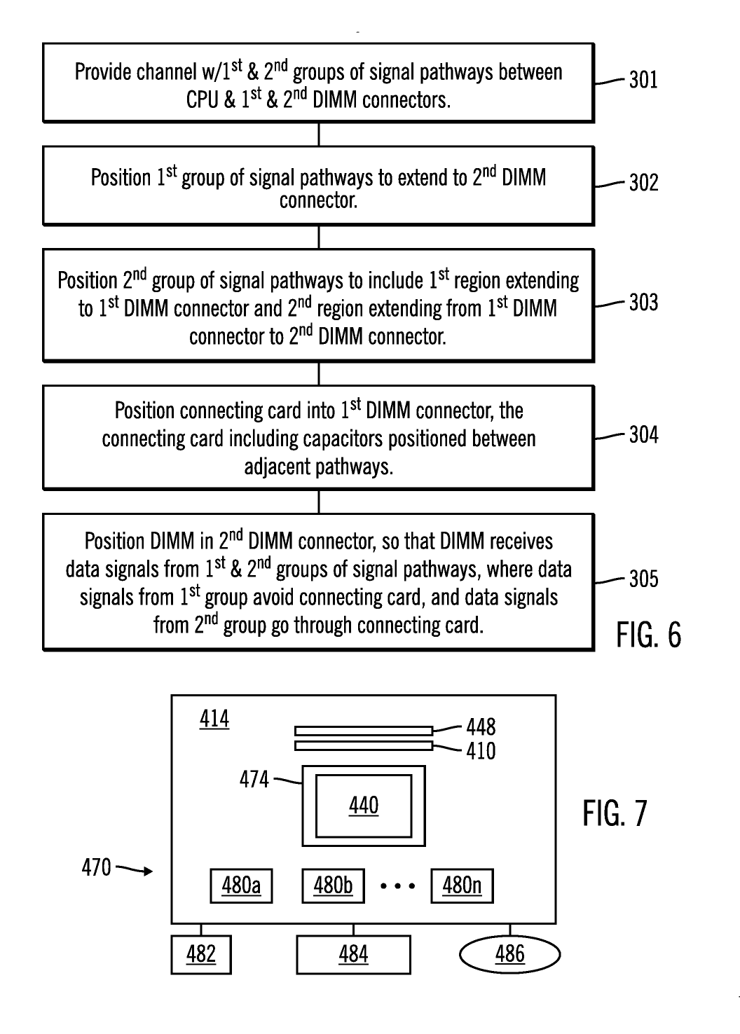

Embodiments also relate to methods for configuring a system, routing signals, and minimizing crosstalk. FIG. 6 is a flowchart of operations, in accordance with certain embodiments. Box 301 is providing a channel with first and second groups of signal pathways routed between a device such as, for example, a memory controller of a CPU and first and second memory connectors such as DIMM connectors. Box 302 is positioning the first group of the signal pathways to extend to the second memory connector. Such signal pathways may be electrically isolated from the first memory connector and electrically coupled to the second memory connector. An example of such signal pathways is shown in the even byte lanes Byte 0, Byte 2, Byte 4, and Byte 6 in FIG. 2. Box 303 is positioning the second group of signal pathways to include a first region extending to the first memory connector (and electrically coupled thereto) and a second region extending from the first memory connector to the second memory connector (and electrically coupled thereto). An example of such signal pathways is shown in the odd byte lanes Byte 1, Byte 3, Byte 5, and Byte 7 in FIG. 2. Box 304 is positioning a connecting card into the first memory connector, the connecting card including electrically conductive pathways, wherein capacitors are positioned between adjacent pathways such as illustrated in FIGS. 1 and 5, for example. Box 305 is positioning a memory module such as a DIMM in the second memory connector. The system is configured so that the DIMM receives data delivered from the first and second groups of signal pathways, where the data signals from the first group avoid the connecting card, and the data signals from the second group pass through the connecting card. FIG. 3 illustrates an example of a signal pathway Byte 0 that avoids the connecting card 110, and FIG. 4 illustrates an example of a signal pathway Byte 7 that passes through the connecting card 110. Various embodiments may omit certain operations or add additional operations to the process, and the order of the operations may be modified.

Assemblies including components formed as described in embodiments above may find application in a variety of electronic components. FIG. 7 schematically illustrates one example of an electronic system environment in which aspects of described embodiments may be embodied. Other embodiments need not include all of the features specified in FIG. 7, and may include alternative features not specified in FIG. 7. The system 470 of FIG. 7 may include at least one die such as a CPU 440 positioned in a package substrate 474, which is then coupled to a substrate such as a PCB 414. The system 470 includes a connecting card 410 and memory module such as a DIMM 448 adjacent to the connecting card 410. While FIG. 7 illustrates one connecting card 410 and one DIMM 448, other numbers of DIMMs and connecting cards are possible. The connecting card 410 and the DIMM 448 may be configured and formed in accordance with embodiments such as described above. A variety of other system components and signal pathways thereto may also include structures having configurations in accordance with the embodiments described above.

The system 470 may further include one or more controllers 480a, 480b . . . 480n, for a variety of components, which may also be disposed on the PCB 414. The system 470 may be formed with additional components, including, but not limited to, storage 482, display 484, and network connection 486. The system 470 may comprise any suitable computing device, including, but not limited to, a mainframe, server, personal computer, workstation, laptop, tablet, netbook, handheld computer, handheld gaming device, handheld entertainment device (for example, MP3 (moving picture experts group layer-3 audio) player), PDA (personal digital assistant) smart phone or other telephony device (wireless or wired), network appliance, virtualization device, storage controller, network controller, router, etc.

Various features of embodiments described above may be implemented with respect to other embodiments, including apparatus and method embodiments. The order of certain operations as set forth in embodiments may also be modified. Specifics in the examples may be used anywhere in one or more embodiments.

In the foregoing description above, various features are grouped together for the purpose of streamlining the disclosure. This method of disclosure is not to be interpreted as reflecting an intention that the claimed embodiments of the invention require more features than are expressly recited in each claim. Rather, as the claims reflect, inventive subject matter may lie in less than all features of a single disclosed embodiment. Thus the claims are hereby incorporated into the Detailed Description, with each claim standing on its own as a separate embodiment.

While certain exemplary embodiments have been described above and shown in the accompanying drawings, it is to be understood that such embodiments are merely illustrative and not restrictive, and that embodiments are not restricted to the specific constructions and arrangements shown and described since modifications may occur to those having ordinary skill in the art. Terms such as “first”, “second”, and the like may be used herein and do not necessarily denote any particular order, quantity, or importance, but are used to distinguish one element from another. Terms such as “upper”, “lower”, “top”, “bottom”, and the like may be used for descriptive purposes only and are not to be construed as limiting. Embodiments may be manufactured, used, and contained in a variety of positions and orientations.

### Examples

The following examples relate to various embodiments.

Example 1 is a connecting card for use in a memory connector, comprising: a substrate including a first substrate region and a second substrate region; a plurality of adjacent signal pathways extending from the first substrate region to the second substrate region; and a capacitor positioned between each of the adjacent signal pathways.

In Example 2, the subject matter of example 1 can optionally include wherein the capacitor comprises a discrete capacitor coupled to the substrate.

In Example 3, the subject matter of any one of examples 1-2 can optionally include wherein the substrate comprises a plurality of layers and the capacitor is positioned in one or more of the layers.

In Example 4, the subject matter of any one of examples 1-3 can optionally include wherein the capacitor is embedded in the substrate.

In Example 5, the subject matter of any one of examples 1-4 can optionally include wherein the plurality of adjacent signal pathways include a first signal pathway adjacent to a second signal pathway, and a third signal pathway adjacent to the second signal pathway, wherein a first capacitor is positioned between the first signal pathway and the second signal pathway, wherein a second capacitor is positioned between the second signal pathway and the third signal pathway, and wherein a third capacitor is positioned between the first signal pathway and the third signal pathway.

In Example 6, the subject matter of any one of examples 1-6 can optionally include at least one additional capacitor positioned between two of the signal pathways.

In Example 7, the subject matter of any one of examples 1-7 can optionally include wherein the connecting card includes a first side and a second side, wherein the first substrate region is positioned on the first side, and wherein the second substrate region is positioned on the second side.

Example 8 is a system comprising: a memory controller; a memory region including a first memory connector and a second memory connector; a channel for delivering data between the memory controller and the memory region, the channel including a first group of signal pathways and a second group of signal pathways; the first group of signal pathways configured to bypass the first memory connector and extend to the second memory connector; the second group of signal pathways each including a first region that extends to the first memory connector and a second region that extends from the first memory connector to the second memory connector; a connecting card positioned in the first memory connector, the connecting card configured to route signals from the first region through the connecting card to the second region, the connecting card comprising a substrate including a first substrate region and a second substrate region, a plurality of adjacent signal pathways extending from the first substrate region to the second substrate region, and a capacitor positioned between each of the adjacent signal pathways; and a memory module positioned in the second memory connector, wherein the memory module is configured to receive data signals from the first group of signal pathways and from the second group of signal pathways.

In Example 9, the subject matter of example 8 can optionally include wherein the capacitor comprises a discrete capacitor coupled to the substrate.

In Example 10, the subject matter of any one of examples 8-9 can optionally include wherein the substrate comprises a plurality of layers and the capacitor is positioned in one or more of the layers.

In Example 11, the subject matter of any one of examples 8-10 can optionally include wherein the capacitor is embedded in the substrate.

In Example 12, the subject matter of any one of examples 8-11 can optionally include wherein the plurality of adjacent signal pathways in the connecting card include a first signal pathway adjacent to a second signal pathway, and a third signal pathway adjacent to the second signal pathway, wherein a first capacitor is positioned between the first signal pathway and the second signal pathway, wherein a second capacitor is positioned between the second signal pathway and the third signal pathway, and wherein a third capacitor is positioned between the first signal pathway and the third signal pathway.

In Example 13, the subject matter of any one of examples 8-12 can optionally include wherein the connecting card further comprises at least one additional capacitor positioned between two of the signal pathways.

In Example 14, the subject matter of any one of examples 8-13 can optionally include wherein the signal pathways in the channel comprise even byte lanes and odd byte lanes, wherein the first group of signal pathways includes the even byte lanes, and wherein the second group of signal pathways includes the odd byte lanes.

In Example 15, the subject matter of any one of examples 8-14 can optionally include wherein the connecting card includes a first side and a second side, wherein the first substrate region is positioned on the first side, and wherein the second substrate region is positioned on the second side.

In Example 16, the subject matter of any one of examples 8-15 can optionally include wherein the memory module comprises a dual in-line memory module (DIMM).

In Example 17, the subject matter of examples 16 can optionally include wherein the DIMM comprises dynamic random access memory (DRAM).

Example 18 is a method for transmitting data in a system comprising: configuring a channel for delivering data between a memory controller and a memory region, the memory region including a first connector and a second connector, the channel configured to include a first group of signal pathways and a second group of signal pathways; positioning the first group of signal pathways to extend to the second connector; positioning the second group of signal pathways to include a first region extending to the first connector and a second region extending from the first connector to the second connector; positioning a connecting card in the first connector, the connecting card configured to route signals from the first region through the connecting card to the second region, the connecting card comprising a substrate including a first substrate region and a second substrate region, a plurality of adjacent signal pathways extending from the first substrate region to the second substrate region, and a capacitor positioned between each of the adjacent signal pathways; and positioning a memory module in the second connector, wherein the memory module is configured to receive data signals from the first group of signal pathways and from the second group of signal pathways; and wherein the data signals from the first group of signal pathways do not travel through the connecting card.

In Example 19, the subject matter of example 18 can optionally include configuring the channel so that the signal pathways in the channel comprise even byte lanes and odd byte lanes, wherein the first group of signal pathways includes the even byte lanes, and wherein the second group of signal pathways includes the odd byte lanes.

In Example 20, the subject matter of any one of examples 18-19 can optionally include configuring the memory module to include DRAM memory.

In Example 21, the subject matter of any one of examples 18-20 can optionally include configuring the connecting card so that the capacitor positioned between each of the adjacent signal pathways comprises a discrete capacitor coupled to the substrate.

In Example 22, the subject matter of any one of examples 18-21 can optionally include wherein the substrate comprises a plurality of layers, and embedding the capacitor within one or more of the layers.

In Example 23, the subject matter of any one of examples 18-22 can optionally include positioning at least one additional capacitor between two of the signal pathways on the connecting card.

In Example 24, the subject matter of any one of examples 18-23 can optionally include wherein the capacitor positioned between each of the adjacent signal pathways on the connecting card is provided by embedding the capacitor in the substrate.

In Example 25, the subject matter of any one of examples 18-24 can optionally include configuring the plurality of adjacent signal pathways on the connecting card to include a first signal pathway adjacent to a second signal pathway, and a third signal pathway adjacent to the second signal pathway, wherein a first capacitor is positioned between the first signal pathway and the second signal pathway, wherein a second capacitor is positioned between the second signal pathway and the third signal pathway, and wherein a third capacitor is positioned between the first signal pathway and the third signal pathway.

In Example 26, the subject matter of any one of examples 18-25 can optionally include configuring the connecting card substrate to include a first side and a second side, wherein the first substrate region is positioned on the first side, and wherein the second substrate region is positioned on the second side.

In Example 27, the subject matter of any one of examples 18-26 can optionally include wherein the memory module is configured to comprise a dual in-line memory module (DIMM).

Example 28 is a method for decreasing crosstalk in a connecting card having a plurality of adjacent signal pathways, comprising positioning a capacitor between each of the adjacent signal pathways.

In Example 29, the subject matter of example 28 can optionally include positioning the connecting card between a memory controller and a memory module in a computing system.

Example 30 is an apparatus comprising: means for routing a plurality of signal pathways on a substrate from a first substrate region to a second substrate region; and means for positioning a capacitor between adjacent signal pathways of the plurality of signal pathways on the substrate.

Example 31 is an apparatus comprising means to perform a method as recited in any preceding example.

What is claimed:

1. A connecting card for use in a memory connector, comprising:
a substrate including a first substrate region and a second substrate region;
a plurality of adjacent signal pathways extending from the first substrate region to the second substrate region; and
a capacitor positioned between each of the adjacent signal pathways.

2. The connection card of claim 1, wherein the capacitor comprises a discrete capacitor coupled to the substrate.

3. The connecting card of claim 1, wherein the substrate comprises a plurality of layers and the capacitor is positioned in one or more of the layers.

4. The connecting card of claim 1, wherein the capacitor is embedded in the substrate.

5. The connecting card of claim 1, wherein the plurality of adjacent signal pathways include a first signal pathway adjacent to a second signal pathway, and a third signal pathway adjacent to the second signal pathway, wherein a first capacitor is positioned between the first signal pathway and the second signal pathway, wherein a second capacitor is positioned between the second signal pathway and the third signal pathway, and wherein a third capacitor is positioned between the first signal pathway and the third signal pathway.

6. The connecting card of claim 1, further comprising at least one additional capacitor positioned between two of the signal pathways.

7. The connecting card of claim 1, wherein the connecting card includes a first side and a second side, wherein the first substrate region is positioned on the first side, and wherein the second substrate region is positioned on the second side.

8. A system comprising:
a memory controller;
a memory region including a first memory connector and a second memory connector;
a channel for delivering data between the memory controller and the memory region, the channel including a first group of signal pathways and a second group of signal pathways;
the first group of signal pathways configured to bypass the first memory connector and extend to the second memory connector;
the second group of signal pathways each including a first region that extends to the first memory connector and a second region that extends from the first memory connector to the second memory connector;
a connecting card positioned in the first memory connector, the connecting card configured to route signals from the first region through the connecting card to the second region, the connecting card comprising a substrate including a first substrate region and a second substrate region, a plurality of adjacent signal pathways extending from the first substrate region to the second substrate region, and a capacitor positioned between each of the adjacent signal pathways; and
a memory module positioned in the second memory connector, wherein the memory module is configured to receive data signals from the first group of signal pathways and from the second group of signal pathways.

9. The system of claim 8, wherein the capacitor comprises a discrete capacitor coupled to the substrate.

10. The system of claim 8, wherein the substrate comprises a plurality of layers and the capacitor is positioned in one or more of the layers.

11. The system of claim 8, wherein the capacitor is embedded in the substrate.

12. The system of claim 8, wherein the connecting card further comprises at least one additional capacitor positioned between two of the signal pathways.

13. The system of claim 8, wherein the signal pathways in the channel comprise even byte lanes and odd byte lanes, wherein the first group of signal pathways includes the even byte lanes, and wherein the second group of signal pathways includes the odd byte lanes.

14. The system of claim 8, wherein the connecting card includes a first side and a second side, wherein the first substrate region is positioned on the first side, and wherein the second substrate region is positioned on the second side.

15. The system of claim 8, wherein the memory module comprises a dual in-line memory module (DIMM).

16. The system of claim 15, wherein the DIMM comprises dynamic random access memory (DRAM).

17. A method for transmitting data in a system comprising:
configuring a channel for delivering data between a memory controller and a memory region, the memory region including a first connector and a second connector, the channel configured to include a first group of signal pathways and a second group of signal pathways;
positioning the first group of signal pathways to extend to the second connector;
positioning the second group of signal pathways to include a first region extending to the first connector and a second region extending from the first connector to the second connector;
positioning a connecting card in the first connector, the connecting card configured to route signals from the first region through the connecting card to the second region, the connecting card comprising a substrate including a first substrate region and a second substrate region, a plurality of adjacent signal pathways extending from the first substrate region to the second substrate region, and a capacitor positioned between each of the adjacent signal pathways; and
positioning a memory module in the second connector, wherein the memory module is configured to receive data signals from the first group of signal pathways and from the second group of signal pathways; and wherein the data signals from the first group of signal pathways do not travel through the connecting card.

18. The method of claim 17, comprising configuring the channel so that the signal pathways in the channel comprise even byte lanes and odd byte lanes, wherein the first group of signal pathways includes the even byte lanes, and wherein the second group of signal pathways includes the odd byte lanes.

19. The method of claim 17, comprising configuring the memory module to include DRAM memory.

20. The method of claim 17, comprising configuring the connecting card so that the capacitor positioned between each of the adjacent signal pathways comprises a discrete capacitor positioned on a surface of the substrate.

21. The method of claim 17, wherein the substrate comprises a plurality of layers, and embedding the capacitor within one or more of the layers.

22. The method of claim 17, further comprising positioning at least one additional capacitor between two of the signal pathways on the connecting card.

23. A method for decreasing crosstalk in a connecting card having a plurality of adjacent signal pathways, comprising positioning a capacitor between each of the adjacent signal pathways.

24. The method of claim 23, further comprising positioning the connecting card between a memory controller and a memory module in a computing system.
